(19) United States
(12) Patent Application Publication
(10) Pub. No.: US 2022/0388157 A1
(43) Pub. Date: Dec. 8, 2022

(54) DESKTOP HORIZONTAL JOINT ROBOT

(71) Applicant: HUILING-TECH ROBOTIC CO., LTD., Shenzhen (CN)

(72) Inventors: JUN TIAN, GUANGDONG (CN); YAOJUN LIU, GUANGDONG (CN); HAO LIU, GUANGDONG (CN)

(21) Appl. No.: 17/338,103

(22) Filed: Jun. 3, 2021

(51) Int. Cl. B25J 9/04; B25J 13/08; B25J 9/10; B25J 9/00; G01D 5/347

(52) U.S. Cl. CPC B25J 9/042; B25J 13/088; B25J 9/104; B25J 9/0009; G01D 5/34746; G01D 5/3473

(57) ABSTRACT

A desktop horizontal joint robot, including: a lift apparatus and a fixation apparatus. The lift apparatus includes: a base, a casing supported on the base, a slider seat liftably arranged within the casing, and a lift driving mechanism configured to move the slider seat. The fixation apparatus includes: a fixation seat in fixed connection with the slider seat, a first rotational shaft rotatably supported at the fixation seat, and a first shaft driving assembly configured to rotate the first rotational shaft. An optical length encoder is arranged within the casing and configured to detect a linear displacement of the slider seat. The fixation apparatus further include a first optical angle encoder configured to detect a rotation angle of the first rotational shaft. The desktop horizontal joint robot features non-wear, high reliability, and long service life.

### BACKGROUND

### 1. Technical Field

The present application relates to the technical field of mechanical arm, and more particularly to a desktop horizontal joint robot.

### 2. Related Art

The current horizontal joint robot arm has been extensively applied, plays very important roles in conveying, processing, assembling environments, features flexible movement, compact structure, low requirement in the space, and high accuracy in repeated positioning, and is capable of accurately and quickly reaching a certain point in the space. Horizontal joint 3-axis robot, when compared with multi-axis industrial robot, is advantageous in small volume, flexibility, and low cost, and the extensive application thereof in the future industrial streamline would be an inevitable tendency. Therefore, it is very necessary to invest more into the research of the horizontal joint 3-axis robot. The current horizontal joint multi-axis robots at home and abroad mainly include the following brands: Epson, Yamaha, and KUKA.

The conventional mechanical arm generally adopts a contact encoder to detect stroke amounts of up-and-down moving parts and rotation angles of arms thereof. However, the contact encoder is prone to wear and has short service life.

### BRIEF SUMMARY OF THE INVENTION

It is an objective of the present application to provide a desktop horizontal joint robot, in order to solve the technical problem in the prior art that the encoder read head is prone to wear and has low reliability due to the use of the contact encoder for the detection of stroke amount and rotation angle.

To achieve the above objectives, in accordance with one embodiment of the present application, it is provided a desktop horizontal joint robot, which comprises:

a lift apparatus, the lift apparatus comprising: a base, a casing supported on the base, a slider seat liftably arranged within the casing, and a lift driving mechanism configured to move the slider seat; and

a fixation apparatus, the fixation apparatus comprising: a fixation seat in fixed connection with the slider seat, a first rotational shaft rotatably supported at the fixation seat, and a first shaft driving assembly configured to rotate the first rotational shaft.

An optical length encoder is arranged within the casing and configured to detect a linear displacement of the slider seat. The fixation apparatus further comprise a first optical angle encoder configured to detect a rotation angle of the first rotational shaft.

In an embodiment of the present application, the supporting frame is arranged within the casing. The optical length encoder comprises: a code strip arranged at a sidewall of the supporting frame, and a length encoder reader head arranged at the slider seat.

In an embodiment of the present application, the optical length encoder is an incremental optical length encoder.

In an embodiment of the present application, the first shaft driving assembly comprises: a first driven synchronous pulley, a first driving synchronous pulley, a first synchronous belt wrapping around the first driven synchronous pulley and the first driving synchronous pulley, and a first rotation-driving motor configured to rotate the first driving synchronous pulley. The first driven synchronous pulley and the first rotational shaft are in fixed connection. The first optical angle encoder comprises: a first code disk fixedly arranged at the first driven synchronous pulley, and a first angle encoder reader head arranged at the fixation seat.

In an embodiment of the present application, the first optical angle encoder is an incremental optical angle encoder.

In an embodiment of the present application, the desktop horizontal joint robot further comprises a first arm apparatus. The first arm apparatus comprises: a first connection seat fixed at the first rotational shaft, a second rotational shaft rotatably supported at the first connection seat, and a second shaft driving assembly configured to rotate the second rotation shaft. The first arm apparatus further comprises a second optical angle encoder configured to detect a rotation angle of the second rotational shaft.

In an embodiment of the present application, the second shaft driving assembly comprises: a second driven synchronous pulley, a second driving synchronous pulley, a second synchronous belt wrapping around the second driven synchronous pulley and the second driving synchronous pulley, and a second rotation-driving motor configured to rotate the second driving synchronous pulley. The second driven synchronous pulley is in fixed connection with the second rotational shaft. The second optical angle encoder comprises: a second code disk fixedly arranged at the second driven synchronous pulley, and a second angle encoder reader head arranged at the fixation seat.

In an embodiment of the present application, the second optical angle encoder is an incremental optical angle encoder.

In an embodiment of the present application, the desktop horizontal joint robot further comprises a second arm apparatus. The second arm apparatus is fixed at the second rotational shaft. The second arm apparatus comprises a second connection seat in connection with the second connection rotational shaft. The second connection rotational seat is provided with a clamp seat.

In an embodiment of the present application, the lift driving mechanism comprises: a top runner, a bottom runner, a lift transmission belt wrapping around the top runner and the bottom runner, and a lift driving assembly configured to enable the lift transmission belt to rotate. The top runner is rotatably supported at a top of the supporting frame within the casing. The bottom runner is rotatably supported at a bottom of the supporting frame. The slider seat is slidably arranged at the supporting frame and is in fixed connection with the lift transmission belt.

Advantages of the desktop horizontal joint robot according to embodiments of the present application are summarized as follows: the desktop horizontal joint robot adopts the optical length encoder to detect the linear displacement of the slider seat, as well as the first optical angle encoder to detect the rotation angle of the first rotational shaft. In this way, by performing the displacement test and rotary angel test with the contactless type optical encoders, no abrasion occurs, which results in more than tens of thousands hours of mechanical average life span, strong anti-interference ability, and high reliability.

### BRIEF DESCRIPTION OF THE DRAWINGS

FIG. 1 is a perspective view of a desktop horizontal joint robot according to an embodiment of the present application;

FIG. 2 is a cross sectional view taken from plane A-A of FIG. 1;

FIG. 3 is a perspective view of a lift apparatus according to an embodiment of the present application;

FIG. 4 is an exploded view of a lift apparatus according to an embodiment of the present application;

FIG. 5 is a cross sectional view taken from plane B-B of FIG. 3;

FIG. 6 is a cross sectional view taken from plane C-C of FIG. 3;

FIG. 7 is a perspective view of a fixation apparatus according to an embodiment of the present application;

FIG. 8 is an exploded view of a fixation apparatus according to an embodiment of the present application;

FIG. 9 is a cross sectional view of a fixation apparatus according to an embodiment of the present application;

FIG. 10 is a front view of a first driven synchronous pulley according to an embodiment of the present application; and

FIG. 11 is exploded view of a first arm apparatus according to an embodiment of the present application.

In the drawings, the following reference numerals are adopted:

1000: Desktop horizontal joint robot; 100: Lift apparatus; 110: Base; 120: Casing; 130: Supporting frame; 140: Slider seat; 150: Lift driving mechanism; 151: Top runner; 152: Bottom runner; 153: Lift transmission belt; 160: Lift driving assembly; 161: Lift driving wheel; 162: Lift driven wheel; 163: Lift driving belt; 164: Lift driving motor; 121: Left casing; 122: Right casing; 23: Top cover; 131: Top fixed shaft; 132: Slide rail; 133: Guide slider; 134: Clamp part; 111: Control board assembly; 112: Lift slot; 171: Upper roller assembly; 172: Lower roller assembly; 173: Dustproof belt; 113: Belt access hole; 174: Roller bracket; 175: Roller shaft; 176: Roller; 181: Spring; 182: Pulley; 190: Optical length encoder; 191: Code strip; 192: Length encoder reader head; 193: Encoder seat; 194: Encoder adapter; 124: Wiring board; 200: Fixation apparatus; 210: Fixation seat; 220: First rotational shaft; 230: First shaft driving assembly; 240: First optical angle encoder; 231: First driven synchronous pulley; 232: First driving synchronous pulley; 233: First synchronous belt; 234: First rotation-driving motor; 241: First code disk; 242: First angle encoder reader head; 211: First limit slot; 300: First arm apparatus; 310: First connection seat; 320: Second rotational shaft; 330: Second shaft driving assembly; 340: Second optical angle encoder; 331: Second driven synchronous pulley; 332: Second driving synchronous pulley; 333: Second synchronous belt; 334: Second rotation-driving motor; 341: Second code disk; 342: Second angle encoder reader head; 350: Bearing seat; 311: Second limit slot; 400: Second arm apparatus; 410: Second connection seat; and 420: Clamp seat.

### DETAILED DESCRIPTION OF EMBODIMENTS OF THE INVENTION

In order to make the purposes, technical solutions, and advantages of the present application clearer and more understandable, the present application will be further described in detail hereinafter with reference to the accompanying drawings and embodiments. It should be understood that the embodiments described herein are only intended to illustrate but not to limit the present application. Based on the described embodiments of the present application, all other embodiments obtained by those skilled in the art without creative work are within the scope of protection of the present application.

In order to enable those skilled in the art to better understand the technical solutions of the present application, the implementation of the present application will be described in detail below in conjunction with specific drawings.

For the convenience of description, technical terms involving “front”, “rear”, “left”, “right”, “up” and “down” are consistent with the front, rear, left, right, up, and down directions in the drawings, but should not be construed as limitation in the structure of the present application.

Unless otherwise defined, the technical terms or scientific terms used herein shall be the ordinary meanings understood by those skilled in the art. terms involving “first”, “second”, and the like used in the specification and claims of the patent application by no means indicate any order, quantity, or importance, but are only used to distinguish different components. Similarly, terms involving “a/an” or “one” do not mean a quantity limit, but mean an existence of “at least one”.

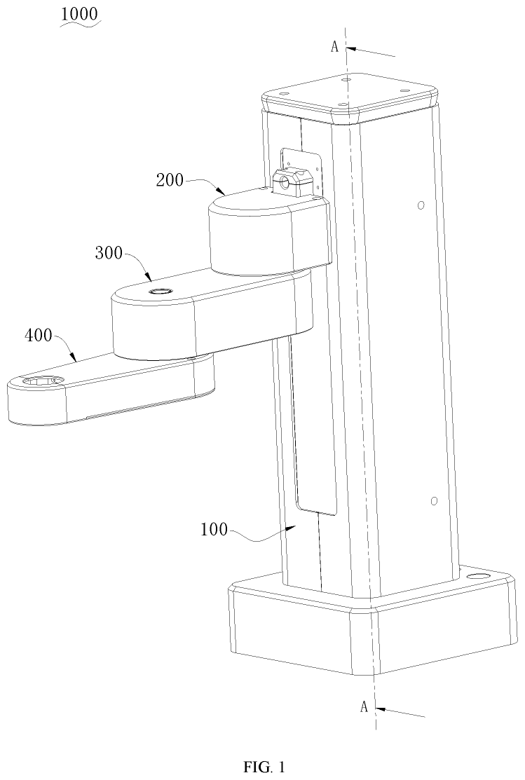

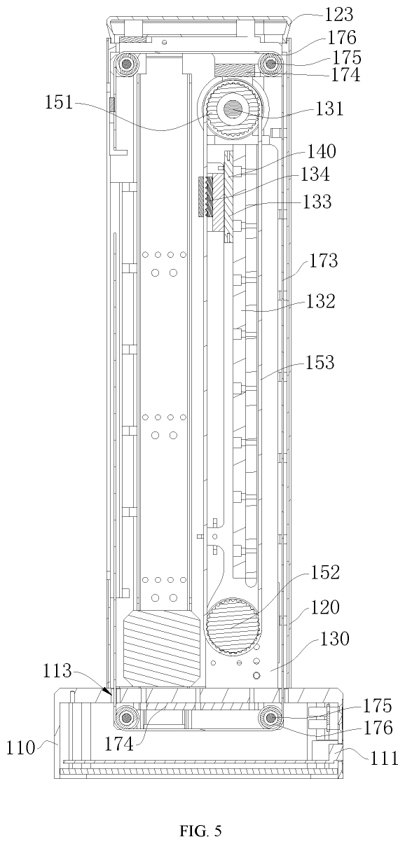

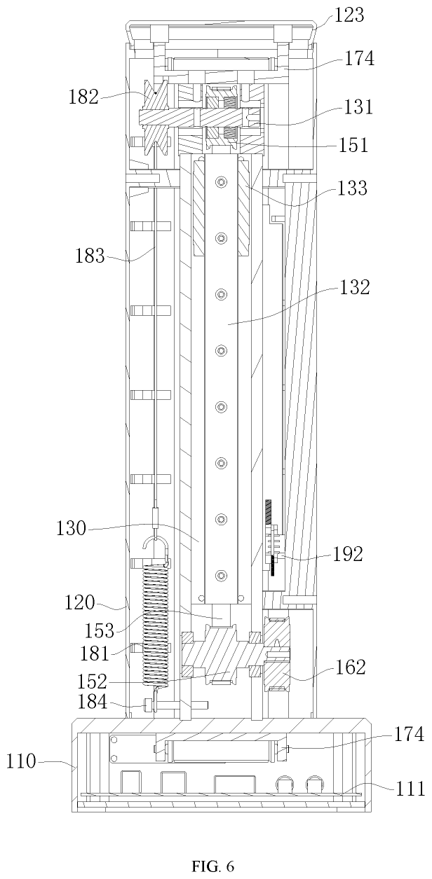

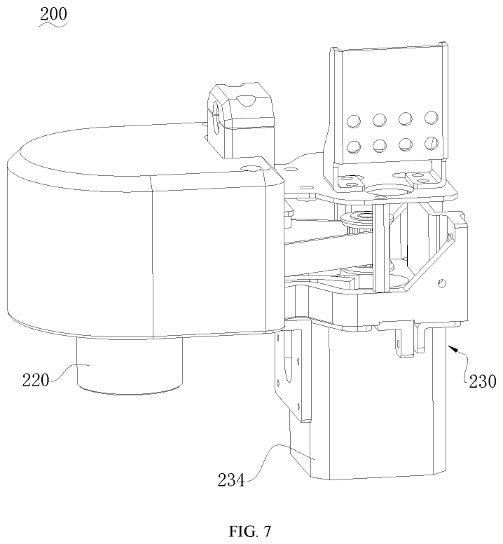

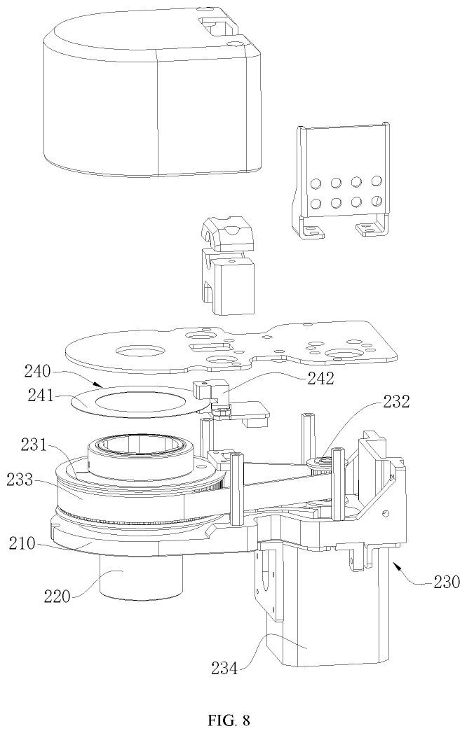

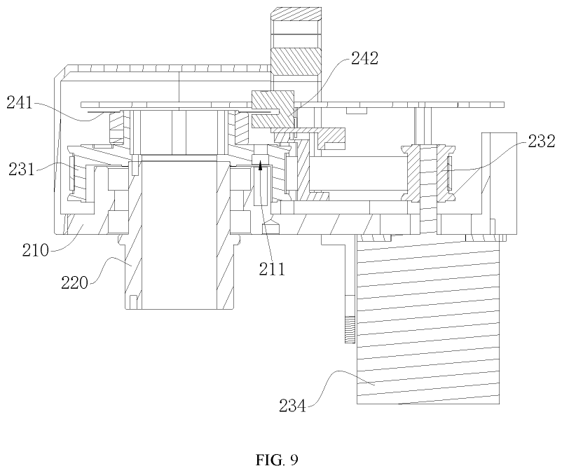

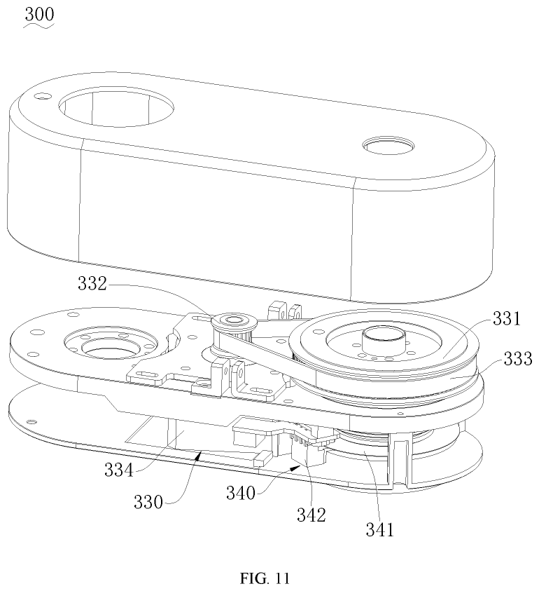

As shown in FIGS. 1-11, a preferred embodiment of a desktop horizontal joint robot is provided by the present application.

As shown in FIGS. 1-6, a desktop horizontal joint robot 1000 according to an embodiment of the present application comprises: a lift apparatus 100 and a fixation apparatus 200. The lift apparatus 100 comprises: a base 110, a casing 120 supported on the base 110, a slider seat 140 liftably arranged within the casing 120, and a lift driving mechanism 150 configured to move the slider seat 140. The fixation apparatus 200 comprises: a fixation seat 210 in fixed connection with the slider seat 140, a first rotational shaft 220 rotatably supported at the fixation seat 210, and a first shaft driving assembly 230 configured to rotate the first rotational shaft 220. An optical length encoder 190 is arranged within the casing 120 and configured to detect a linear displacement of the slider seat 140. The fixation apparatus 200 further comprise a first optical angle encoder 240 configured to detect a rotation angle of the first rotational shaft 220.

The desktop horizontal joint robot 1000 adopts the optical length encoder 190 to detect the linear displacement of the slider seat 140, as well as the first optical angle encoder 240 to detect the rotation angle of the first rotational shaft 220. In this way, by performing the displacement test and rotary angel test with the contactless type optical encoders, no abrasion occurs, which results in more than tens of thousands hours of mechanical average life span, strong anti-interference ability, and high reliability.

As show in FIGS. 1-6, the desktop horizontal joint robot 1000 according to this embodiment of the present application comprises: the lift apparatus 100 and the fixation apparatus 200. The lift apparatus 100 comprises: the base 110, the casing 120 supported on the base 110, the slider seat 140 liftably arranged within the casing 120, and the lift driving mechanism 150 configured to move the slider seat 140.

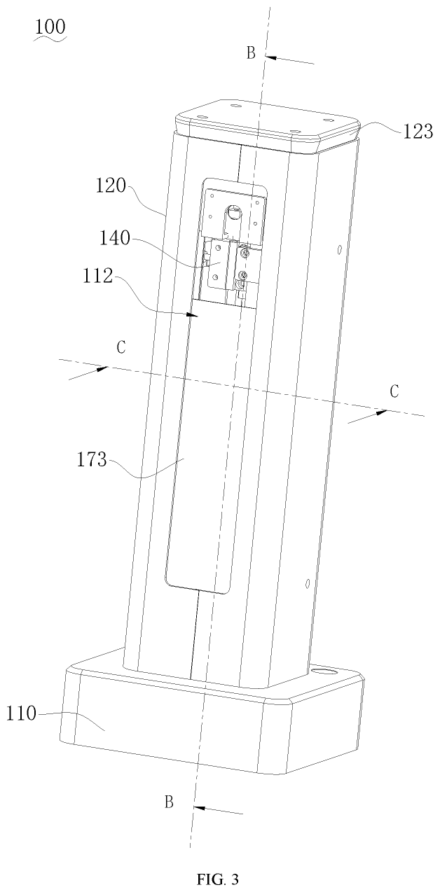

As shown in FIGS. 3-6, the lift apparatus 100 according to this embodiment of the present application comprises: the base 110, the casing 120, the supporting frame 130, the slider seat 140, and the lift driving mechanism 150.

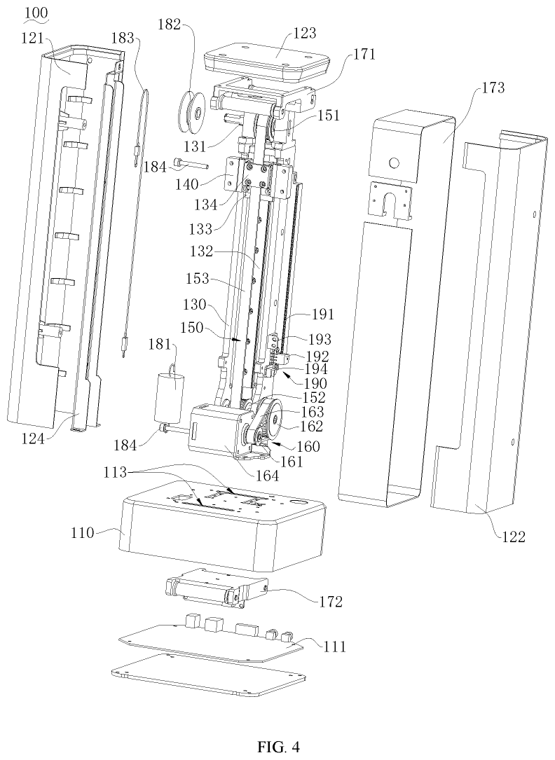

It can be known from FIGS. 3-4 that the casing 120 is supported on the base 110, the supporting frame 130 is arranged within the casing 120 and supported by the base 11. The casing 120 consists of, but is not limited to, a left casing 121 (left side casing shown in the figures), a right casing 122 (right side casing shown in the figures), and a top cover 123. The left casing 121 and the right casing 122 are in fixed connection with the supporting frame 130 by means of any existing fixation manner, for example, by screws, the top cover 123 covers upper ends (upper ends as shown in the figures) of the left casing 121 and the right casing 122 and are in fixed connection with the left casing 121 and the right casing 122 by means of any existing fixation manner, for example by screws or snapping manner. The supporting frame 130 is in fixed connection with the base 110 by any existing fixation manner, for example, by screws, so as to fix and connect the casing 120 at the base 110.

As shown in FIGS. 3-6, the lift driving mechanism 150 comprises: a top runner 151, a bottom runner 152, a lift transmission belt 153, and a lift driving assembly 160. The top runner 151 and the bottom runner 152 are wrapped around by the lift transmission belt 153. The lift driving assembly 160 is configured to enable the lift transmission belt 153 to rotate. The top runner 151 is rotatably supported at a top of the supporting frame 130, and the bottom runner 152 is rotatably supported at a bottom of the supporting frame 130. The slider seat 140 is slidably arranged at the supporting frame 130 and is in fixed connection with the lift transmission belt 153. A top fixed shaft 131 is arranged at the top of the supporting frame 130, and a bottom rotational shaft is arranged at the bottom of the supporting frame 130. The top runner 151 is sleeved outside the top fixed shaft 131 via a bearing and is rotatable relative to the top fixed shaft 131. A side wall of the supporting frame 130 defines therein a reniform hole extending in a height direction (the up-down direction as shown in the figures), such that the position of the top fixed shaft 131 to be vertically adjustable at the supporting frame 130 and cannot be rotatable relative to the supporting frame 130. The tightness of the lift transmission belt 153 can be adjusted by vertically adjusting the position of the top fixed shaft 131. The bottom rotational shaft is rotationally supported at the supporting frame 130 via a bearing, and the bottom runner 152 is integrally formed with the bottom rotational shaft. The lift transmission belt 153 is not limited to the synchronous belt, and the top runner 151 and the bottom runner 152 are not limited to the synchronous runners. The lift driving assembly 160 is in transmission connection with the bottom rotational shaft, and it can be understood that under the driving of the lift driving assembly 160, the bottom rotational shaft is enabled to drive the bottom runner 152 to rotate, which in turn drives the lift transmission belt 153 to rotate and enables the slider seat 140 moves vertically (the up-down direction as shown in the figures) relative to the supporting frame 130.

In another embodiment, the top fixed shaft 131 is fixed arranged at the supporting frame 130.

In another embodiment, the bottom rotational shaft is rotatably supported at the supporting frame 130 through a bearing, the bottom runner 152 is sleeved outside the bottom rotational shaft, and the bottom runner 152 and the bottom rotational shaft are in non-rotatable connection, for example, by means of key connection, tight fit, etc.

In another embodiment, the lift driving assembly 160 and the top runner 151 are in transmission connection so as to drive the top runner 151 to rotate.

As shown in FIGS. 3-6, in this embodiment, the supporting frame 130 is provided thereon with a slide rail 132, the slide rail 132 is provided thereon with a guide slider 133, the guide slider 133 is slidably arranged on the slide rail 132, and the slider seat 140 is in fixed connection with the guide slider 133. In this embodiment, the slide rail 132 is in fixedly connected at the supporting frame 130 by means of any existing fixation manner, such as screws, and extends in a direction perpendicular to a top surface of the base 110 (that is, the up-down direction in the figures); and the slider seat 140 is fixedly connected to the guide slider 133 by means of any existing fixation manner, such as screws. It can be easily understood that the lifting of the slider seat 140 can be guided and oriented via the slide rail 132 and the guide slider 133 slidable on the slide rail 132, such that the movement stability of the slider seat 140 during the lifting movement is ensured.

In another embodiment, a guide slot or guide rod may be arranged at the supporting frame 130 and the slider seat is slidable in the guide slot, or alternatively, in connection with the guide rode via a linear bearing.

As shown in FIGS. 3-6, a clamp part 134 is arranged at the lift transmission belt 153 and the claim member 134 comprises a pair of clamp elements. An inner surface of each clamping member has teeth matching a surface of the lift transmission belt 153, and the two clamping members are in fixed connection by means of any existing fixation manner, such as screws, so that the two clamping members can vertically move along with the rotation of the lift transmission belt 153. The slider seat can be in fixed connection with the clam part 134 by means of any existing fixation manner, such as screws, which is convenient for the mounting and dismounting of the slider seat 140, and thereby convenient for the displacement and maintenance of the parts.

As shown in FIGS. 3-6, the lift driving assembly 160 comprises: a lift driving wheel 161, a lift driven wheel 162, a lift driving belt 163, and a lift driving motor 164. The lift driving wheel 161 and the lift driven wheel 162 are wrapped around by the lift driving belt 163. The lift driving motor 164 is configured to drive the lift driving wheel 161 to rotate, and is supported on the base 110. The lift driven wheel 162 and the bottom runner 152 are connected and coaxially arranged. In this embodiment, the lift driving motor 164 is a stepping motor; the lift driving belt 163 is, but not limited to, a synchronous belt; and the lift driving wheel 161 and the lift driven wheel 162 are, but not limited to, synchronous wheels. The driving motor 164 is fixedly installed at the base 110 by means of any existing fixation manner, for example, screws, and the lift driving wheel 161 is installed at an output shaft of the lift driving motor 164. The lift driven wheel 162 is sleeved outside the bottom rotational shaft; and the lift driven wheel 162 and the bottom rotational shaft are in non-rotatable connection, for example, by means of key connection, tight fit, etc. A control board assembly 111 is arranged inside the base 110 and is electrically connected to the lift driving motor 164. It can be easily understood that the lift driving wheel 161 is driven by the lift driving motor 164 to rotate and in turn to drive the bottom runner 152 to rotate, by utilizing the lift driven wheel 162, thereby realizing the lifting movement of the slider seat 140.

As shown in FIGS. 3-5, the casing 120 defines a lift slot 112 in a sidewall thereof and extending in a direction perpendicular to a top surface of the base 110. The lift apparatus 100 further comprises: an upper roller assembly 171 arranged at the top of the supporting frame 130, a lower roller assembly 172 arranged in the base 110, and a dustproof belt 173 wrapping around the upper roller assembly 171 and the lower roller assembly 172 and configured to shield the lift slot 112. The base 110 defines therein belt access holes 113 configured to allow the dustproof belt 173 to pass therethrough. In this embodiment, the number of the belt access holes 113 is not limited to two, and the two belt access holes 113 respectively communicate with an inside of the casing 120 and an inside of the base 110. The dustproof belt 173 is not limited to a flexible stainless steel belt, and has two free ends respectively mounted to the fixation apparatus 200, and the fixation apparatus 200 is in fixed connection with the slider seat 140. Each of the upper roller assembly 171 and the lower roller assembly 172 comprises: a roller bracket 174, roller shafts 175 supported by the roller bracket 174, and rollers 176 rotatably arranged on the roller shafts 175, respectively. The roller bracket 174 of the upper roller assembly 171 is fixedly mounted at the top of the supporting frame 130 by means of any existing fixation manner, for example, screws, and the top cover 123 is in fixed connection with the roller bracket 174 by screws. The roller bracket 174 of the lower roller assembly 172 is fixedly mounted inside the base 110 by means of any existing fixation manner, for example, screws. It may be understood that the upper roller assembly 171 and the lower roller assembly 172 are configured to guide the dustproof belt 173, in this way, the rotation of the dustproof belt 173 is guided during the lifting movement of the fixation apparatus 200 along the slider seat 140, thereby realizing the shielding of the lift slot 112 during the lifting of the slider seat 140 and in turn preventing dusts from entering the casing 120.

As shown in FIGS. 4-6, a spring 181 is arranged within the casing 120, and two ends of the spring 181 are connected to the supporting frame 130 and the slider seat 140, respectively. In this embodiment, the spring 181 is not limited to a stretchable spring. A pulley 182 is arranged at the top of the supporting frame 130 and is sleeved outside the top fixed shaft 131, and the pulley 182 and the top fixed shaft 131 are in rotational connection via a bearing. A towing cable 183 is suspended around the pulley 182 and is in fixed connection with the slider seat 140. The towing cable 183 is not limited to a steel line. One end of the spring 181 is fixed at the bottom of the supporting frame 130 via a side fastener 184, and the other end of the spring 181 is in fixed connection with one end of the towing cable 183. The other end of the towing cable 183 that is opposite to the one end of the towing cable 183 in connection with the spring 181 is fixed on the slider seat 140 via a side fastener 184. The side fastener 184 may be screws, bolts, pins, etc. It may be noted that the spring 181 is used for counterweight. On the one hand, the slider seat 140 and external apparatuses carried thereon can be braked once the robot is powered off, so as to prevent the slider seat 140 and the external apparatuses carried thereon from falling immediately due to their own weight; and on the other hand, the pulling force of the spring 181 can be used to offset a part of the weight of the slider seat 140 and external apparatuses carried thereon, which is beneficial to manually drag the slider seat 140 and the external apparatuses carried thereon to move upwards or downwards, thereby realizing the drag teaching.

As shown in FIGS. 4-6, the lift apparatus 100 further comprises an optical length encoder 190. The optical length encoder 190 comprises: a code strip 191 arranged at a sidewall of the supporting frame 130, and a length encoder reader head 192 arranged at the slider seat 140. In this embodiment, the optical length encoder 190 is not limited to an incremental optical length encoder, which comprises: a code strip 191, an encoder seat 193, a length encoder reader head 192, and an encoder adapter 194. The code strip 191 has a grid-like scale. The length encoder reader head 192 is in electric connection with the encoder adapter 194. The encoder seat 193 is fixedly installed at the slider seat 140, and the length encoder reader head 192 and the encoder adapter 194 are fixedly mounted at the encoder seat 193, so as to move upwards or downwards along with the slider seat 140, thereby detecting information of the slider seat 140, including displacement or position thereof.

As shown in FIGS. 1-2, 7, and 9, the fixation apparatus 200 comprises: a fixation seat 210 in fixed connection with the slider seat 140, a first rotational shaft 220 rotatably supported at the fixation seat 210, and a first shaft driving assembly 230 configured to rotate the first rotational shaft 220. The fixation apparatus 200 further comprises a first optical angle encoder 240 configured to detect the rotation angle of the first rotational shaft 220. In this embodiment, the first shaft driving assembly 230 comprises: a first driven synchronous pulley 231, a first driving synchronous pulley 232, a first synchronous belt 233 wrapping around the first driven synchronous pulley 231 and the first driving synchronous pulley 232, and a first rotation-driving motor 234 configured to rotate the first driving synchronous pulley 232. The first driven synchronous pulley 231 and the first rotational shaft 220 are in fixed connection. The first optical angle encoder 240 comprises: a first code disk 241 fixedly arranged at the first driven synchronous pulley 231, and a first angle encoder reader head 242 arranged at the fixation seat 210.

In particular, the fixation seat 210 is fixedly mounted at the slider seat 140 by means of any existing fixation manner, for example, screws, thereby moving upwards or downwards along with the up-and-down movement of the slider seat 140. The first rotational shaft 220 is supported at the fixation seat 210 via a bearing, and the first driven synchronous pulley 231 is in fixed connection with the first rotational shaft 220 in a manner of coaxial arrangement. The first driving synchronous pulley 232 is fixedly installed at an output shaft of the first rotation-driving motor 234. The first optical angle encoder 240 is not limited to an incremental optical angle encoder, which comprises: a first code disk 241, a first angle encoder reader head 242, and an encoder adapter. The first code disk 241 has a grid-like scale. The first angle encoder reader head 242 is in electric connection with the encoder adapter. The first angle encoder reader head 242 and the encoder adapter are fixedly mounted at the fixation seat 210. The first code disk 241 is fixed at the first driven synchronous pulley 231 in a manner of coaxial arrangement, so as to rotate along with the first driven synchronous pulley 231, in this way, a rotation angle of the first rotational shaft 220 is detected, and a rotation angel of a first arm apparatus in connection with the first rotational shaft 220 can be detected.

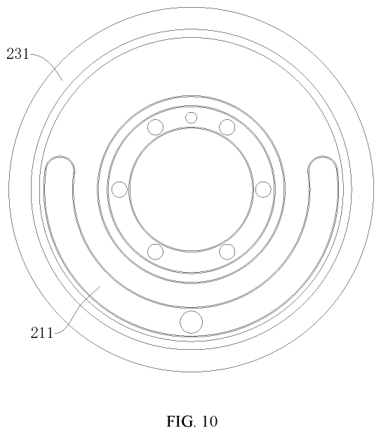

It can be known from FIG. 10, as a further improvement, a limit pin (not shown in the figure) is arranged at the fixation seat 210, and the first driven synchronous pulley 231 defines therein a first limit slot 211 configured to fit with the limit pin such that the rotation angel of the first arm apparatus is restricted, thereby ensuring that a maximum rotation angel thereof to either the left or the right is 98°.

As shown in FIGS. 1-2 and 11, the desktop horizontal joint robot 1000 in this embodiment further comprises a first arm apparatus 300, which comprises: a first connection seat 310 fixed at the first rotational shaft 220, a second rotational shaft 320 rotatably supported at the first connection seat 310, and a second shaft driving assembly 330 configured to rotate the second rotation shaft 320. The first arm apparatus 300 further comprises a second optical angle encoder 340 configured to detect a rotation angle of the second rotational shaft 320. In this embodiment, the second shaft driving assembly 330 comprises: a second driven synchronous pulley 331, a second driving synchronous pulley 332, a second synchronous belt 333 wrapping around the second driven synchronous pulley 331 and the second driving synchronous pulley 332, and a second rotation-driving motor 334 configured to rotate the second driving synchronous pulley 332. The second driven synchronous pulley 331 is in fixed connection with the second rotational shaft 320. The second optical angle encoder 340 comprises: a second code disk 341 fixedly arranged at the second driven synchronous pulley 331, and a second angle encoder reader head 342 arranged at the fixation seat 210.

In particular, the first connection seat 310 is fixedly mounted at the first rotational shaft 220 by means of any existing fixation manner, for example, screws, and is rotatable relative to the fixation seat 210 around an axis of the first rotational shaft 220. The second rotational shaft 320 is rotatably supported at the first connection seat 310 via the bearing seat 350. The second driven synchronous pulley 331 and the second rotational shaft 320 are coaxially arranged and in fixed connection. The second driving synchronous pulley 332 is fixedly mounted at an output shaft of the second rotation-driving motor 334. The second optical angle encoder 340 is not limited to an incremental optical angle encoder and comprises: a second code disk 341, a second angle encoder reader head 342, and an encoder adapter. The second code disk 341 has a grid-like scale, the second angle encoder reader head 342 is in electric connection with the encoder adapter. The second angle encoder reader head 342 and the encoder adapter are fixedly mounted at the first connection seat 310. The second code disk 341 is fixed at the second driven synchronous pulley 331 in a manner of coaxial arrangement, so as to rotate along with the rotation of the second driven synchronous pulley 331, in this way, the rotation angle of the second rotational shaft 320 can be detected, so as to detect the rotation angel of a second arm apparatus in connection with the second rotational shaft 320.

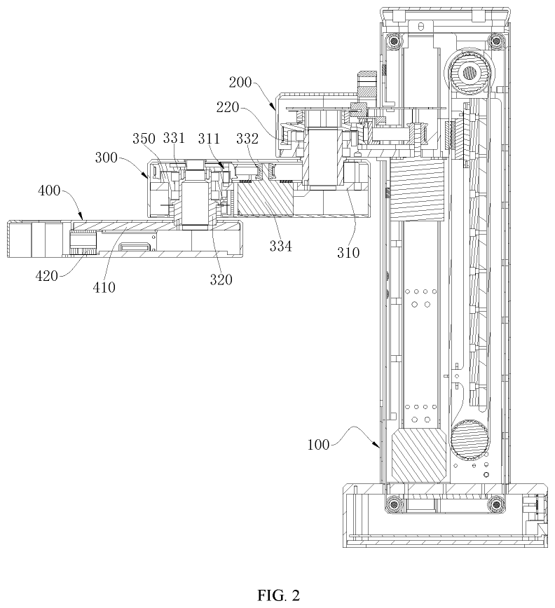

It can be known from FIG. 2, as a further improvement, a limit pin (not shown in the figure) is arranged at the bearing seat 350, and the second driven synchronous pulley 331 defines therein a second limit slot 311 configured to fit with the limit pin such that the rotation angel of the second arm apparatus is restricted, thereby ensuring that a maximum rotation angel thereof to either the left or the right is 159°.

As shown in FIG. 2, the desktop horizontal joint robot 1000 in this embodiment further comprises a second arm apparatus 400. The second arm apparatus 400 is fixed at the second rotational shaft 320. In this embodiment, the second arm apparatus 400 comprises a second connection seat 410 in connection with the second connection rotational shaft 320. The second connection rotational seat 410 is provided with a clamp seat 420. A 3D printing nozzle, a vacuum chuck, an electric gripper, a writing brush, an electric soldering irons, a laser light source can be installed at an end of the second arm apparatus 400 via the clamp seat 420, thereby realizing functions including 3D printing, stacking, writing, soldering circuit boards, and laser sintering.

The above is only the preferred embodiments of the present application, and is not intended to limit the application. Any modifications, equivalent substitutions, and improvements made within the spirit and principles of the present application are included in the protection scope of the present application.

What is claimed is:

1. A desktop horizontal joint robot, comprising:
a lift apparatus, the lift apparatus comprising: a base, a casing supported on the base, a slider seat liftably arranged within the casing, and a lift driving mechanism configured to move the slider seat; and
a fixation apparatus, the fixation apparatus comprising: a fixation seat in fixed connection with the slider seat, a first rotational shaft rotatably supported at the fixation seat, and a first shaft driving assembly configured to rotate the first rotational shaft; wherein
an optical length encoder is arranged within the casing and configured to detect a linear displacement of the slider seat; and
the fixation apparatus further comprise a first optical angle encoder configured to detect a rotation angle of the first rotational shaft.

2. The desktop horizontal joint robot of claim 1, wherein
the supporting frame is arranged within the casing; and
the optical length encoder comprises: a code strip arranged at a sidewall of the supporting frame, and a length encoder reader head arranged at the slider seat.

3. The desktop horizontal joint robot of claim 1, wherein the optical length encoder is an incremental optical length encoder.

4. The desktop horizontal joint robot of claim 1, wherein
the first shaft driving assembly comprises: a first driven synchronous pulley, a first driving synchronous pulley, a first synchronous belt wrapping around the first driven synchronous pulley and the first driving synchronous pulley, and a first rotation-driving motor configured to rotate the first driving synchronous pulley;
the first driven synchronous pulley and the first rotational shaft are in fixed connection; and
the first optical angle encoder comprises: a first code disk fixedly arranged at the first driven synchronous pulley, and a first angle encoder reader head arranged at the fixation seat.

5. The desktop horizontal joint robot of claim 1, wherein the first optical angle encoder is an incremental optical angle encoder.

6. The desktop horizontal joint robot of claim 1, further comprising a first arm apparatus; wherein
the first arm apparatus comprises: a first connection seat fixed at the first rotational shaft, a second rotational shaft rotatably supported at the first connection seat, and a second shaft driving assembly configured to rotate the second rotation shaft; and
the first arm apparatus further comprises a second optical angle encoder configured to detect a rotation angle of the second rotational shaft. The desktop horizontal joint robot of claim 6, wherein
the second shaft driving assembly comprises: a second driven synchronous pulley, a second driving synchronous pulley, a second synchronous belt wrapping around the second driven synchronous pulley and the second driving synchronous pulley, and a second rotation-driving motor configured to rotate the second driving synchronous pulley;
the second driven synchronous pulley is in fixed connection with the second rotational shaft; and
the second optical angle encoder comprises: a second code disk fixedly arranged at the second driven synchronous pulley, and a second angle encoder reader head arranged at the fixation seat.

8. The desktop horizontal joint robot of claim 6, wherein the second optical angle encoder is an incremental optical angle encoder.

9. The desktop horizontal joint robot of claim 6, further comprising a second arm apparatus; wherein
the second arm apparatus is fixed at the second rotational shaft;
the second arm apparatus comprises a second connection seat in connection with the second connection rotational shaft; and
the second connection rotational seat is provided with a clamp seat.

10. The desktop horizontal joint robot of claim 1, wherein
the lift driving mechanism comprises: a top runner, a bottom runner, a lift transmission belt wrapping around the top runner and the bottom runner, and a lift driving assembly configured to enable the lift transmission belt to rotate;
the top runner is rotatably supported at a top of the supporting frame within the casing;
the bottom runner is rotatably supported at a bottom of the supporting frame; and
the slider seat is slidably arranged at the supporting frame and is in fixed connection with the lift transmission belt.
